(19) United States
(12) Patent Application Publication
(10) Pub. No.: US 2023/0325718 A1
(43) Pub. Date: Oct. 12, 2023

(54) METHOD AND APPARATUS FOR JOINT TRAINING LOGISTIC REGRESSION MODEL

(71) Applicant: ALIPAY (HANGZHOU) INFORMATION TECHNOLOGY CO., LTD., Hangzhou (CN)

(72) Inventors: Jinming Cui, Hangzhou (CN); Li Wang, Hangzhou (CN)

(73) Assignee: ALIPAY (HANGZHOU) INFORMATION TECHNOLOGY CO., LTD., Hangzhou (CN)

(21) Appl. No.: 18/194,336

(22) Filed: Mar. 31, 2023

(30) Foreign Application Priority Data
Apr. 2, 2022 (CN) 202210346184.1

(51) Int. Cl. G06N 20/00; H04L 9/08

(52) U.S. Cl. CPC G06N 20/00; H04L 9/085

(57) ABSTRACT

A first party of two parties performs masking on three first-party fragments corresponding to three types of training data split into fragments and distributed between the two parties by using first fragments of three random numbers in a first fragment of a random array to obtain three first mask fragments sent to a second party, the first fragment of the random array is a fragment, sent by a third party to the first party, of two-party fragments obtained by splitting values in the random array generated by the third party. Three pieces of mask data are constructed by using the three first mask fragments and three second mask fragments received from the second party. A first calculation based on the three pieces of mask data and the first fragment of the random array is performed to obtain a first gradient fragment for updating the first-party fragment of the model parameter.

### TECHNICAL FIELD

One or more embodiments of this specification relate to the field of data processing technologies, and in particular, to methods and apparatuses for jointly training a logistic regression model.

### BACKGROUND

Data are the basis of machine learning, but in most industries, data often exist in the form of silos in consideration of issues such as privacy security of the data, and there are many obstacles to achieving centralized integration of data even between different departments of the same company. In view of the dilemma between data silos and data privacy, the industry proposed federated learning (FL), also known as federated machine learning, joint learning, or consortium learning. FL is a machine learning framework designed to help multiple data parties to use data and model machine learning while satisfying privacy security of the data.

A logistic regression (LR) model is a widely used machine learning model, and training the LR model under the FL framework is a hot research topic. However, an existing method for jointly training the LR model is too complex to satisfy practical application needs.

Therefore, a solution for jointly training the LR model is needed to better satisfy the practical application needs, for example, reducing communication traffic. and calculation amounts among multiple participants.

### SUMMARY

One or more embodiments of this specification describe methods and apparatuses for jointly training a logistic regression model. A secret sharing technology is described and a random number fragment is sent by a third party so as to construct mask data corresponding to a sample characteristic, a model parameter, and a sample label, thereby implementing secure calculation of a gradient fragment and effectively reducing communication traffic and calculation amounts among participants.

According to a first aspect, a method for jointly training a logistic regression model is provided. The training includes three types of training data: a sample characteristic, a sample label, and a model parameter, and each of the three types of training data is split into fragments that are distributed between two parties. The method is performed by either first party of the two parties, and includes: performing masking on three first-party fragments corresponding to the three types of training data by respectively using first fragments of three random numbers in a first fragment of a random array to obtain three first mask fragments, and sending the three first mask fragments to a second party, where the first fragment of the random array is a fragment, sent by a third party to the first party, of two-party fragments that are obtained by splitting values in the random array generated by the third party; constructing three pieces of mask data corresponding to the three types of training data by using the three first mask fragments and three second mask fragments received from the second party; and performing a first calculation based on the three pieces of mask data and the first fragment of the random array to obtain a first gradient fragment for updating the first-party fragment of the model parameter, where the first calculation is determined based on a Taylor expansion of a gradient calculation of the logistic regression model.

In some embodiments, the first party holds the sample characteristic and the second party holds the sample label; and before obtaining the three first mask fragments, the method further includes: splitting the sample characteristic into a corresponding first-party fragment and a corresponding second-party fragment by using a secret sharing technology, and sending the second-party fragment to the second party; and receiving, from the second party, a first-party fragment obtained by splitting the sample label by using the secret sharing technology.

In some embodiments, before obtaining the three first mask fragments, the method further includes: after initializing the model parameter, splitting the model parameter into a corresponding first-party fragment and a corresponding second-party fragment, and sending the second-party fragment to the second party; or receiving, from the second party, a first-party fragment obtained by splitting the initialized model parameter by using the secret sharing technology.

In some embodiments, the performing masking on three first-party fragments corresponding to the three types of training data by respectively using first fragments of three random numbers to obtain three first mask fragments includes: for any type of training data, performing masking on a first-party fragment of the type of training data by using a first fragment of a random number having the same dimension as the type of training data to obtain a corresponding first mask fragment.

In some embodiments, the constructing three pieces of mask data corresponding to the three types of training data by using the three first mask fragments and three second mask fragments received from the second party includes: for any type of training data, constructing corresponding mask data by using a first mask fragment and a second mask fragment of the type of training data.

In some embodiments, the random array further includes a fourth random number; the three random numbers include a second random number corresponding to the model parameter; the three pieces of mask data include characteristic mask data corresponding to the sample characteristic; after constructing, the three pieces of mask data corresponding to the three types of training data and before obtaining the first gradient fragment, the method further includes: determining a first product mask fragment corresponding to a product result of the second random number and the characteristic mask data based on a first fragment of the second random number, the characteristic mask data, and a first fragment of the fourth random number, and sending the first product mask fragment to the second party; constructing product mask data corresponding to the product result by using the first product mask fragment and a second product mask fragment corresponding to the product result received from the second party; and the performing a first calculation based on the three pieces of mask data and the first fragment of the random array includes: further performing the first calculation based n the product mask data.

In some embodiments, the random array further includes a plurality of additional values, and the plurality of additional values are values obtained by the third party by performing an operation based on the three random numbers; the performing a first calculation based on the three pieces of mask data and the first fragment of the random array to obtain a first gradient fragment includes: calculating gradient mask data corresponding to a training gradient based on the three pieces of mask data; calculating a first removal fragment for a mask in the gradient mask data based on the three pieces of mask data, the first fragments of the three random numbers, and a first fragment of the plurality of additional values; and performing de-masking on the gradient mask data by using the first removal fragment to obtain the first gradient fragment, or determining the first removal fragment as the first gradient fragment.

In some embodiments, after obtaining the first gradient fragment, the method further includes: subtracting a product of a predetermined learning rate and the first gradient fragment from the first-party fragment of the model parameter as an updated first-party fragment of the model parameter.

According to a second aspect, an apparatus for jointly training a logistic regression model is provided. The training includes three types of training data: a sample characteristic, a sample label, and a model parameter, and each of the three types of training data is split into fragments that are distributed between two parties. The apparatus is integrated into either first party of the two parties, and includes: a masking unit, configured to perform masking on three first-party fragments corresponding to the three types of training data by respectively using first fragments of three random numbers in a first fragment of a random array to obtain three first mask fragments, and send the three first mask fragments to a second party, where the first fragment of the random array is a fragment, sent by a third party to the first party, of two-party fragments that are obtained by splitting values in the random array generated by the third party; a data reconstruction unit, configured to construct three pieces of mask data corresponding to the three types of training data by using the three first mask fragments and three second mask fragments received from the second party; and a gradient fragment calculation unit, configured to perform a first calculation based on the three pieces of mask data and the first fragment of the random array to obtain a first gradient fragment for updating the first-party fragment of the model parameter, where the first calculation is determined based on a Taylor expansion of a gradient calculation of the logistic regression model.

According to a third aspect, a computer-readable storage medium is provided. The computer-readable storage medium stores a computer program, and when the computer program is executed on a computer, the computer is enabled to perform the method according to the first aspect.

According to a fourth aspect, a computing device is provided, including a memory and a processor. The memory stores executable code, and the processor executes the executable code to implement the method according to the first aspect.

According to the methods and the apparatuses provided in some embodiments of this specification, a secret sharing technology is described and a random number fragment is sent by a third party so as to construct mask data corresponding to a sample characteristic, a model parameter, and a sample label, thereby implementing secure calculation of a gradient fragment and effectively reducing communication traffic and calculation amounts among participants.

### BRIEF DESCRIPTION OF DRAWINGS

To describe the technical solutions in some embodiments of this application more dearly, the following briefly describes the accompanying drawings needed for describing some embodiments. Clearly, the accompanying drawings in the following description are merely some embodiments of this application, and a person of ordinary skill in the art can still derive other drawings from these accompanying drawings without creative efforts.

FIG. 1 is a diagram illustrating a communication architecture for jointly training a logistic regression model, according to some embodiments;

FIG. 2 is a schematic diagram illustrating multi-party interaction for jointly training a logistic regression model, according to some embodiments; and

FIG. 3 is a schematic structural diagram illustrating an apparatus for jointly training a logistic regression model, according to some embodiments.

### DESCRIPTION OF EMBODIMENTS

The solutions provided in this specification are described below with reference to the accompanying drawings.

As described previously, logistic regression (LR) is a machine learning algorithm with a wide range of application scenarios, such as user classification or product recommendation, etc. Typically, a gradient calculation formula for the LR model is as follows:

$$∇ w = \frac{1}{m} ( σ ( {wx}^{T} ) - {y}^{T} ) x \qquad ( 1 )$$

In the above formula, x represents a sample characteristic, x∈ [symbol] ^{m×n}, where m represents a quantity of samples in a batch of training samples, and n represents a quantity of characteristics in a single training sample; w represents a model parameter, w∈ [symbol] ⁿ; y represents a sample label, y∈ [symbol] ^{m×1}; T represents a transpose operator; ∇w represents a gradient of the model parameter;

$$σ ( t ) = \frac{1}{1 + {e}^{- t}}$$

represents a logistic function or sigmoid function.

During joint training of the LR model, calculating a gradient by directly using the above T formula (1) is very complex. Therefore, it is proposed to simplify the calculation of the gradient through linear approximation of the logistic function, usually a Taylor expansion of the logistic function, for example, by using the first-order Taylor expansion of the logistic function, as shown in the following formula (2), to simplify the formula (1) into the form of formula (3).

$$σ ( t ) = \frac{1}{2} + \frac{1}{4} t \qquad ( 2 )$$

$$∇ w = \frac{1}{m} ( \frac{1}{2} + \frac{1}{4} {wx}^{T} - {y}^{T} ) x \qquad ( 3 )$$

Based on the formula (3), only two operations of addition and multiplication are needed to complete a secure logistic regression operation.

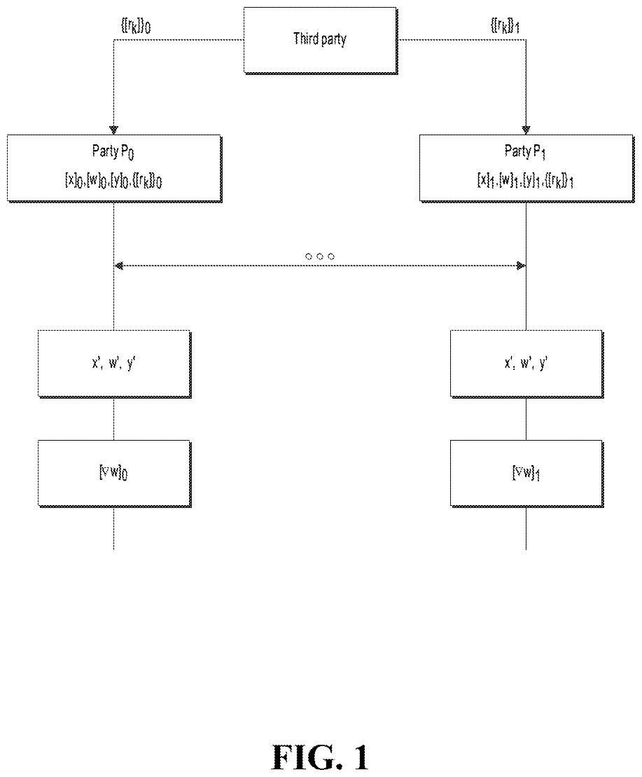

Further, some embodiments of this specification disclose a solution for training the LR model by jointly calculating an approximation of the gradient of the LR model, for example, by using the joint calculation formula (3). As shown in FIG. 1, in this solution, the three types of training data, namely, the model parameter w, the sample characteristic x, and the sample label y, are split into fragments that are distributed between two parties. Either party Pᵢ (or referred to as the party i, i=0 or 1) of the two parties holds training data fragments [w]ᵢ, [x]ᵢ, and [y]ᵢ. In any round of iterative training, the party Pᵢ interacts with the other parties (or referred to as party P_{ī} or party ī below, ī≠i) of the two parties (the interaction process is schematically indicated by a double-headed arrow and an ellipsis in FIG. 1) based on a party i fragment {[rₖ]ᵢ}_{k∈[1,N]} of a random array {rₖ}_{k∈[1,N]} received from a third party other than the two parties, and a party i fragment of the training data held by the party Pᵢ, to reconstruct mask data w′, x′, and y′. Then, the party Pᵢ calculates a party i gradient [∇w]ᵢ of the gradient based on the mask data and the party i fragment {[rₖ]ᵢ}_{k∈[1,N}] of the random array so as to update a party i fragment [w]ᵢ of the model parameter. It is worthwhile to note that, for brevity of description, the, subscripts k∈[1, N] outside the set sign {} are omitted below.

As such, secure update ate of the gradient fragment is implemented by constructing, the mask data.

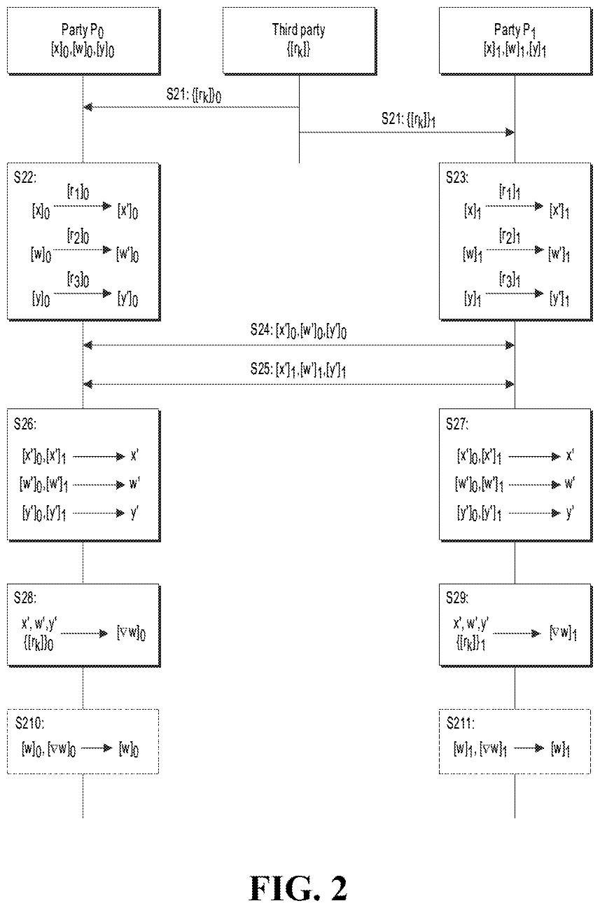

The implementation steps of the above solution are described below with reference to some specific embodiments. FIG. 2 is a schematic diagram illustrating multi-party interaction for jointly training a logistic regression model, according to some embodiments, As shown in FIG. 2, multiple parties include a party P₀, a party P₁, and a third party, and each party can be implemented as any apparatus, server, platform, device cluster, or the like having computing and processing capabilities.

For ease of understanding, sources of training data fragments in the party P₀ and the party P₁ are described first. The party P₀ and the party P₁ jointly maintain raw sample data. In some possible scenarios, the party P₀ holds sample characteristics x a plurality of training samples, and the party P₁ holds sample labels y of the plurality of training samples. For example, the party P₀ holds user characteristics of a plurality of users, and the party P₁ holds classification labels of the plurality of users. In some other possible scenarios, the party P₀ holds a part of sample characteristics of a plurality of training samples, and the party P₁ holds sample labels of the plurality of training samples and another part of the sample characteristics. For example, the bank holds bank transaction data of a plurality of users, and the credit reference agency holds loan data and credit ratings of the plurality of users. In still some other possible scenarios, the party P₀ and the party P₁ hold different training samples, for example, hold payment samples collected based on different payment platforms.

Further, the two parties each split the sample data into two fragments based on the held sample data and by using a secret sharing (SS) technology, retain one of the fragments, and send the other fragment to the other parties. It should be understood that the SS technology is a basic technology for secure calculation. Raw data are split at random and then distributed. Each piece of distributed data is held by a different manager, and a single (or a protocol-specified quantity or less) data holder cannot perform secret restoration. For example, a process of performing secret sharing on the raw data can include the following: first selecting a security level parameter (system default or manual selection) and generating a corresponding finite field (e.g., 2²⁵⁶); and then uniformly selecting a random number s₁∈ [symbol] ₂_{²⁵⁶} within the finite field and calculating s₂=s−s₁ so that s₁ and s₂ are used as two fragments of the raw data s and are distributed to two different managers.

Based on the above description, in some embodiments, the party P₀ splits the sample characteristic x it holds into two characteristic fragments and sends one of the two characteristic fragments to the party P₁. Correspondingly, the characteristic fragment sent to the party P₁ is denoted as [x]₁, and the other characteristic fragment remaining in the party P₀ is denoted as [x]₀. Similarly, the party P₁ splits the sample label y it holds into label fragments [y]₀ and [y]₁, and sends the fragment [y]₀ to the party P₀ and retains the fragment [y]₁.

As such, the party P₀ and the party P₁ each hold a characteristic fragment and a label fragment. In addition, the training of the LR model includes a plurality of rounds of iterations. To select sample data fragments to be used for different rounds, for example, the party P₀ performs a plurality of rounds of sampling based on identifiers (e.g., sample numbers) of all samples, and sends sampling results to the party P₁. As such, in each round of iterative training, each party determines a currently used characteristic fragment and label fragment based on identifiers of samples corresponding to the current round of iteration. For brevity of description, the characteristic fragment and the label fragment that the party P₁ uses in any round of iteration are still denoted as [x]ᵢ and [y]ᵢ below.

In addition, for the parameter fragments held by the party P₀ and the party P₁, before the first round of iterative training is performed on the LR model, either party Pᵢ can initialize the model parameter w, and split the model parameter into two fragments by using the SS technology, and then send one of the two fragments to the other parties. As such, the party Pᵢ can perform the first round of iterative training based on the fragment of the initialized model parameter. Further, in each subsequent round of iteration, the party Pᵢ takes part in the current round of iteration by using the parameter fragment obtained after the update in the previous round of iteration. For brevity of description, the parameter fragment that the party Pᵢ uses in any round of iteration is still denoted as [w]ᵢ below.

The sources of training data fragments that the party P₀ and the party P₁ hold have been described above.

Any round of iterative training during joint training is described below. As shown in FIG. 2, the multi-party interaction process in any round includes the following:

In step S21, a third party sends a party i fragment of the random array {rₖ} generated by the third party to the party Pᵢ, including sending a party 0 fragment {[rₖ]₀} of the random array to the party P₀, and sending a party 1 fragment {[rₖ]₁} of the random array to the party P₁.

Specifically, the third party generates a plurality of random numbers to form the random array {rₖ}, splits each random number rₖ into two fragments [rₖ]₀ and [rₖ]₁ by using the secret sharing technology so as to form the party 0 fragment {[rₖ]₀} of the random array and the party 1 fragment {[rₖ]₁} of the random array, and then sends the two fragments to the party P₀ and the party P₁, respectively. It is worthwhile to note that there are actually many methods for splitting the random number rₖ, for example, by using the following formula (4) or (5).

rₖ=[rₖ]₀+[rₖ]₁ (4)

rₖ=[rₖ]₀−[rₖ]₁ (5)

Further, the random array {rₖ} includes at least random numbers r₁, r₂, and r₃ having the same dimensions as the model parameter w, the sample characteristic x, and the sample label y, respectively. Correspondingly, the party i fragment {[rₖ]ᵢ} of the random array includes at least party i fragments of three random numbers: [r₁]ᵢ, [r₂]ᵢ, and [r₃]ᵢ.

It should be understood that for different rounds of iterative training, the third party usually needs to regenerate a random array {rₖ}, thereby ensuring privacy security of the data during the interaction.

It can be determined from the above description that, the party Pᵢ can obtain the party i fragment {[rₖ]ᵢ} of the random array for the current round of iterative training. It is worthwhile to note that, for clarity and brevity of the following description, two steps with similar processes respectively performed by the party P₀ and the party P₁ during the interaction are collectively denoted as being performed by the party Pᵢ for centralized description.

Next, in steps S22 (i=0) and S23 (i=1), the party Pᵢ performs masking on party i fragments [x]ᵢ, [w]ᵢ, and [y]ᵢ of three pieces of training data that the party Pᵢ holds by using party i fragments [r₁]ᵢ, [r₂]ᵢ, and [r₃]ᵢ of three random numbers in a party i fragment {[rₖ]ᵢ} of the random array, to obtain party i fragments [x′]ᵢ, [w′]ᵢ, and [y′]ᵢ of three masks.

Specifically, for any type of training data, the party Pᵢ performs masking on a party i fragment of the training data by using a party i fragment of a random number having the same dimension as the type of training data to obtain a party i fragment of a corresponding mask. It is worthwhile to note that the masking can be implemented based on addition or subtraction operations, and masking methods used for different types of training data can be the same or different.

In some embodiments, the party Pᵢ performs masking on party i fragments of different training data by using the same method, for example, by using the following formula (6):

[x′]ᵢ=[x]ᵢ−[r₁]ᵢ

[w′]ᵢ=[w]ᵢ−[r₂]ᵢ

[y′]ᵢ=[y]ᵢ−[r₃]ᵢ (6)

In some other embodiments, the party Pᵢ performs masking on party i fragments of different training data by using different methods, for example, by using the following formula (7):

[x′]ᵢ=−[x]ᵢ−[r₁]ᵢ

[w′]ᵢ=[w]ᵢ+[r₂]ᵢ

[y′]ᵢ=−[y]ᵢ+[r₃]ᵢ (7)

As such, the party Pᵢ can obtain party i fragments [x′]ᵢ, [w′]ᵢ, and [y′]ᵢ of three masks. It is worthwhile to further note that, for the same type of training data, the methods in which two parties perform masking on their fragments are usually designed to be the same, but can be different. For example, the party P₀ calculates [x′]₀=[x]₀−[r₁]₀ and the party P₁ calculates [x′]₁=[x]₁+[r₁]₁.

It can be determined from the above description that, the party Pᵢ can obtain party i fragments of three masks so that the party Pᵢ sends the party i fragments of the three masks to the other parties in step S24 (i=0) and step S25 (i=1).

Next, in step S26 (i=0) and step S27 (i=1), the party Pᵢ constructs three pieces of mask data x′, w′, and y′ corresponding to three types of training data by using the party i fragments [x′]ᵢ, [w′]ᵢ, and [y′]ᵢ of three masks and party ī fragments [x′]_{ī}, [w′]_{ī}, and [y′]_{ī} of three masks received from the other parties. It should be understood that mask data of any type of training data are equivalent to data obtained by directly performing masking on the type of training data by using a corresponding random number. In addition, the mask data construction method adapts to the following: the method in which the third party splits the random number into fragments and the methods in which two parties respectively perform masking on the training data fragments by using the random number fragments.

According to some typical embodiments, the third party splits the random number rₖ into fragments by using formula (4), the party Pᵢ determines the party i fragment of the mask by using formula (6), and the other parties determine the party ī fragment of the mask by using the same method as the party Pᵢ. As such, in this step, the party Pᵢ can reconstruct the mask data by using the following formula (8).

x′=[x′]ᵢ+[x′]_{ī}

w′=[w′]ᵢ+[w′]_{ī}

y′=[y′]ᵢ+[y′]_{ī} (8)

It can be determined from the above description that, the party Pᵢ can reconstruct three pieces of mask data: x′, w′, and y′. Then, in step S28 (i=0) and step S29 (i=1), the party Pᵢ performs a calculation based on the three pieces of reconstructed mask data x′, w′, and y′, and the party i fragment {[rₖ]ᵢ} of the random array held by the parry Pᵢ, to obtain the party i fragment [∇w]ᵢ of the gradient.

It is worthwhile to note that the calculation formula for the party i fragment [∇w]ᵢ of the gradient is designed based on the Taylor expansion of the gradient calculation of the LR model, or referred to as a gradient calculation formula below, for example, the above formula (3). Specifically, the gradient calculation formula relates to the three types of training data. Correspondingly, an expression, formed based on the three types of mask data and three random numbers, corresponding to the three types of training data is substituted into the gradient calculation formula so as to obtain an expression between a gradient truth value ∇w and both of a gradient mask value ∇w′ and mask removal data M.

∇w=∇w′+M (9)

For example, an expression corresponding to three types of training data shown in formula (10) is substituted into the above formula (3) so as to obtain formula (11).

x=x′+r₁

w=w′+r₂

y=y′+r₃ (10)

$$∇ w = \frac{1}{m} ( \frac{1}{2} + \frac{1}{4} {wx}^{T} - {y}^{T} ) x = \frac{1}{4 m} ( 2 x + {wx}^{T} x - {y}^{T} x ) = \frac{1}{4 m} [ 2 ( {x}^{′} + {r}_{1} ) + ( {w}^{′} + {r}_{2} ) {( {x}^{′} + {r}_{1} )}^{T} ( {x}^{′} + {r}_{1} ) - {( {y}^{′} + {r}_{3} )}^{T} ( {x}^{′} + {r}_{1} ) ) = \frac{1}{4 m} [ ( 2 {x}^{′} + {w}^{′} {x}^{′ T} {x}^{′} - {y}^{′ T} {x}^{′} ) ] + M \qquad ( 11 )$$

It should be understood that in in the above formula is a quantity of characteristics in a sample, is not related to privacy, and can be held by both parties. For the calculation of the party i fragment [∇w]ᵢ of the gradient, it can be designed based on formula (9) that, ∇w′ is calculated based on three types of mask data, and a party i fragment [M]ᵢ of mask removal data M (or briefly referred to as removal data) is calculated based on the party i fragment {[rₖ]ᵢ} of the random array.

Specifically, in this step, the party Pᵢ at least needs to calculate the party i fragment [M]ᵢ of the removal data. Further, in some embodiments, it can be inferred by observing formula (11) that, the expression of the removal data M includes a plurality of calculation items related to random numbers r₁, r₂, and r₃. Therefore, it can be designed that the random array {rₖ} further includes a plurality of additional values obtained by performing an operation based on the random numbers r₁, r₂, and r₃. Correspondingly, the party Pᵢ can determine the party i fragment [M]ᵢ of the removal data based on party i fragments of the plurality of additional values, party i fragments of the random numbers r₁, r₂, and r₃, and the three pieces of reconstructed mask data.

In addition, in some embodiments, the expression of the removal data M in formula (11) includes a calculation item r₂x′^{T}r₁. Therefore, it can be designed that the party Pᵢ reconstructs product mask data e′ corresponding to r₂x′^{T}, thereby implementing secure calculation for the r₂x′^{T}r₁ and further implementing secure calculation for the removal data M.

According to some specific embodiments, the random array {rₖ} further includes the random number r₄. Therefore, before this step is performed, the method further includes the following: the party Pᵢ determines a party i fragment [e′]ᵢ of a product mask corresponding to a product result e(=r₂x′^{T}) based on [r₂]ᵢ and [r₄]ᵢ in the party i fragment {[rₖ]ᵢ} of the random array, and characteristic mask data x′, and sends the party i fragment [e′]ᵢ of the product mask to the other parties; and further, the party Pᵢ reconstructs the product mask data e′ by using [e′]ᵢ and the party ī fragment [e′]_{ī} of the product mask received from the other parties. In some examples, the party Pᵢ calculates the party i fragment [e′]ᵢ of the product mask and reconstructs the product mask data e′ by using the following formulas (12) and (13).

[e′]ᵢ=[r₂]ᵢx′^{T} −[r₄]ᵢ (12)

e′=[e′]ᵢ+[e′]_{ī} (13)

As such, the party Pᵢ can calculate the product mask data e′ before this step is performed. It is worthwhile to note that, for the calculation item r₂x′^{T}r₁, it can be further designed that the party Pᵢ reconstructs the mask data corresponding to x′^{T}r₁. The specific reconstruction process can be adaptively designed.

Further, in this step, the party Pᵢ can calculate the party i fragment [M]ᵢ of the removal data based on the reconstructed product mask data e′ and the party i fragment {[rₖ]ᵢ} of the random array.

In addition, the gradient mask data ∇w′ in formula (9) can be calculated by either of the party Pᵢ and the other parties, for example, can be calculated by the party Pᵢ alone or can be calculated by both parties, provided that through design, ∇w′ can be restored based on a result of calculation for ∇w′ performed by the party Pᵢ and a result of calculation for ∇w′ performed by the other parties. For example, the party Pᵢ calculates αᵢ∇w′, and the sum of αᵢ∇w′ and αᵢ∇w′ calculated by the other parties is ∇w′.

Based on the above description, in this step, according to some embodiments, the party Pᵢ calculates the party i fragment [M]ᵢ of the removal data as the party i fragment [∇w]ᵢ of the gradient. According to some other embodiments, the party Pᵢ calculates the gradient mask data ∇w′ and the party i fragment [M]ᵢ of the removal data, and uses the stun of the gradient mask data ∇w′ and the party i fragment [M]ᵢ of the removal data as the party i fragment [∇w]ᵢ of the gradient, namely, [∇w]ᵢ=∇w′+[M]ᵢ. According to some other embodiments, the party Pᵢ uses the sum of weighted data αᵢ∇w′ of the gradient mask data ∇w′ and the party i fragment [M]ᵢ of the removal data as the party i fragment [∇w]ᵢ of the gradient, namely, [∇w]ᵢ=αᵢ∇w′+[M]ᵢ.

Further, in some examples, the random array {rₖ} includes random numbers r₁, r₂, r₃, and r₄, as well as additional values c₁, c₂, c₃, c₄, and c₅, where c₁=r₂r₁^{T}, c₂=r₂r₁^{T}r₁, c₃=r₃^{T}r₁, c₄=r₄r₁, c₅=r₁^{T}r₁. In addition, the masking mentioned in the above steps is subtracting a mask from the processed data, and the splitting into fragments is splitting the raw data into two addition fragments, namely, s=s₁+s₂.

Correspondingly, in step S28, the party P₀ calculates the party 0 fragment [M] of the removal data as the party 0 fragment [∇w]₀ of the gradient by using the following formula (14). In step S29, the party P₁ calculates the sum result of the gradient mask data ∇w′ and the party 1 fragment [M]₁ of the removal data as the party 1 fragment [∇w]₁ of the gradient by using the following formula (15).

$${[ ∇ w ]}_{0} = \frac{1}{4 m} ( {2 [ {r}_{1} ]}_{0} + ( {{w}^{′} [ {r}_{1} ]}_{0}^{T} {x}^{′} + {[ {r}_{2} ]}_{0} {( {x}^{′} )}^{T} {x}^{′} + {{{w}^{′} ( {x}^{′} )}^{T} [ {r}_{1} ]}_{0} ) - 4 {( {( {y}^{′} )}^{T} ) [ {r}_{1} ]}_{0} + {[ {r}_{3} ]}_{0}^{T} {x}^{′} ) + {[ {c}_{1} ]}_{0} {x}^{′} + {{w}^{′} [ {c}_{5} ]}_{0} + {{e}^{′} [ {r}_{1} ]}_{0} + {[ {c}_{4} ]}_{0} + {[ {c}_{2} ]}_{0} - {4 [ {c}_{3} ]}_{0} ) \qquad ( 14 )$$

$${[ ∇ w ]}_{1} = \frac{1}{4 m} ( 2 {x}^{′} + {2 [ {r}_{1} ]}_{1} + ( {{w}^{′} ( {x}^{′} )}^{T} {x}^{′} + {{w}^{′} [ {r}_{1} ]}_{1}^{T} {x}^{′} + {[ {r}_{2} ]}_{1} {( {x}^{′} )}^{T} {x}^{′} + {{{w}^{′} ( {x}^{′} )}^{T} [ {r}_{1} ]}_{1} ) - 4 {( {( {y}^{′} )}^{T} {x}^{′} + {( {y}^{′} )}^{T} ) [ {r}_{1} ]}_{1} + {[ {r}_{3} ]}_{1}^{T} {x}^{′} ) + {[ {c}_{1} ]}_{1} {x}^{′} + {{w}^{′} [ {c}_{5} ]}_{1} + {{e}^{′} [ {r}_{1} ]}_{1} + {[ {c}_{4} ]}_{1} + {[ {c}_{2} ]}_{1} - {4 [ {c}_{3} ]}_{1} ) \qquad ( 15 )$$

As such, the party Pᵢ can calculate the party i fragment [∇w]ᵢ of the gradient for updating the party i fragment [w]ᵢ of the model parameter.

According to some embodiments in another aspect, the method can further include steps S210 (i=0) and S211 (i=1). The party Pᵢ subtracts a product of the predetermined learning rate β and the party i fragment [∇w]ᵢ of the gradient from the party i fragment [w]ᵢ of the model parameter, and uses a result as an updated fragment [w]ᵢ, namely:

[w]ᵢ=[w]ᵢ−β*[∇w]ᵢ (16)

As such, the party Pᵢ can update the party i fragment [∇w]ᵢ of the gradient. It is worthwhile to further note that the relative execution order of the above steps is not unique, provided that the execution logic is not affected. Moreover, the above method steps can be repeated to update the LR model in multiple rounds of iterations until the quantity of iterations reaches a predetermined quantity or the model parameter reaches a predetermined convergence criterion, thereby obtaining a final LR model. For example, the party P₀ and the party P₁ can send each other a parameter fragment obtained through update in the last round of iterations so that both parties locally construct complete model parameters.

In conclusion, according to the method for jointly training a logistic regression model disclosed in some embodiments of this specification, a secret sharing technology is described and a random number fragment is sent by a third party so as to construct mask data corresponding to a sample characteristic, a model parameter, and a sample label, thereby implementing secure calculation of a gradient fragment and effectively reducing communication traffic and calculation amounts among participants.

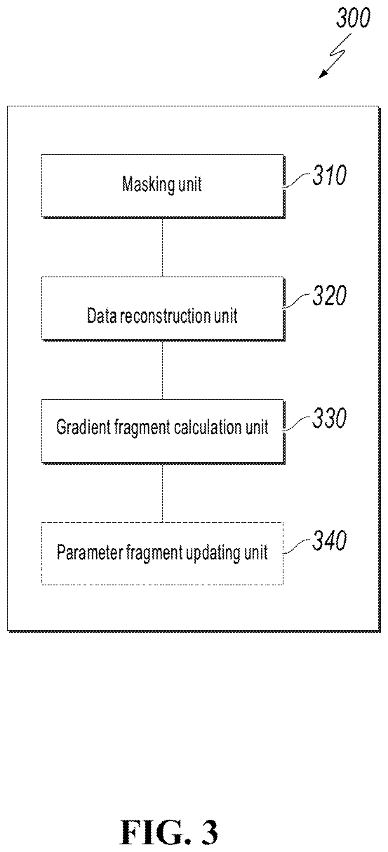

Corresponding to the above training method, some embodiments of this specification further disclose training apparatuses. FIG. 3 is a schematic structural diagram illustrating an apparatus for jointly training a logistic regression model, according to some embodiments. The training includes three types of training data: a sample characteristic, a sample label, and a model parameter, and each of the three types of training data is split into fragments that are distributed between two parties. The apparatus is integrated into either first party of the two parties. As shown in FIG. 3, the apparatus 300 includes: a masking unit 310, configured to perform masking on three first-party fragments corresponding to the three types of training data by respectively using first fragments of three random numbers in a first fragment of a random array to obtain three first mask fragments, and send the three first mask fragments to a second party, where the first fragment of the random array is a fragment, sent by a third party to the first party, of two-party fragments that are Obtained by splitting values in the random array generated by the third party; a data reconstruction unit 320, configured to construct three pieces of mask data corresponding to the three types of training data by using the three first mask fragments and three second mask fragments received from the second party; and a gradient fragment calculation unit 330, configured to perform a first calculation based on the three pieces of mask data and the first fragment of the random array to obtain a first gradient fragment for updating the first-party fragment of the model parameter, where the first calculation is determined based on a Taylor expansion of a gradient calculation of the logistic regression model.

In some embodiments, the first party holds the sample characteristic and the second party holds the sample label. The apparatus 300 further includes: a fragment sending unit, configured to split the sample characteristic into a corresponding first-party fragment and a corresponding second-party fragment by using a secret sharing technology, and send the second-party fragment to the second party; and a fragment receiving unit, configured to receive, from the second party, a first-party fragment obtained by splitting the sample label by using the secret sharing technology.

In some embodiments, the apparatus 300 further includes a parameter processing unit, configured to: after initializing the model parameter, split the model parameter into a corresponding first-party fragment and a corresponding second-party fragment, and send the second-party fragment to the second party.

In some embodiments, the apparatus 300 further includes a parameter fragment receiving unit, configured to receive, from the second party, a first-party fragment obtained by splitting the initialized model parameter by using the secret sharing technology.

In some embodiments, the masking unit 310 is specifically configured to: for any type of training data, perform making on a first-party fragment of the type of training data by using a first fragment of a random number having the same dimension as the type of training data to obtain a corresponding first mask fragment.

In some embodiments, the data reconstruction unit 320 is specifically configured to: for any type of training data, construct corresponding mask data by using a first mask fragment and a second mask fragment of the type of training data.

In some embodiments, the random array further includes a fourth random number, the three random numbers include a second random number corresponding to the model parameter, and the three pieces of mask data include characteristic mask data corresponding to the sample characteristic. The apparatus further includes a product masking unit, configured to determine a first product mask fragment corresponding to a product result of the second random number and the characteristic mask data based on a first fragment of the second random number, the characteristic mask data, and a first fragment of the fourth random number, and send the first product mask fragment to the second party; and construct product mask data corresponding to the product result by using the first product mask fragment and a second product mask fragment corresponding to the product result received from the second party. The gradient fragment calculation unit 330 is specifically configured to further perform the first calculation based on the product mask data.

In some embodiments, the random array further includes a plurality of additional values, and the plurality of additional values are values obtained by the third party by performing an operation based on the three random numbers. The gradient fragment calculation unit 330 is specifically configured to calculate gradient mask data corresponding to a training gradient based on the three pieces of mask data; calculate a first removal fragment for a mask in the gradient mask data based on the three pieces of mask data, the first fragments of the three random numbers, and a first fragment of the plurality of additional values; and perform de-masking on the gradient mask data by using the first removal fragment to obtain the first gradient fragment. Alternatively, the gradient fragment calculation unit 330 is specifically configured to determine the first removal fragment as the first gradient fragment.

In some embodiments, the apparatus 300 further includes a parameter fragment updating unit 340, configured to subtract a product of a predetermined learning rate and the first gradient fragment from the first-party fragment of the model parameter as an updated first-party fragment of the model parameter.

According to some embodiments in another aspect, a computer-readable storage medium is further provided, where the computer-readable storage medium stores a computer program, and when the computer program is executed in a computer, the computer is enabled to perform the method described with reference to FIG. 2.

According to some embodiments in yet another aspect, a computing device is further provided, including a memory and a processor, where the memory stores executable code, and the processor executes the executable code to implement the method described with reference to FIG. 2.

A person skilled in the art should be aware that in the above-mentioned one or more examples, functions described in this application can be implemented by hardware, software, firmware, or any combination thereof. When being implemented by software, these functions can be stored in a computer-readable medium or transmitted as one or more instructions or code in the computer-readable medium.

The above-mentioned some specific implementations further describe the purposes, technical solutions, and beneficial effects of this application. It should be understood that the previous descriptions are merely some specific implementations of this application and are not intended to limit the protection scope of this application. Any modification, equivalent replacement, or improvement made based on the technical solutions of this application shall fall within the protection scope of this application.

What is claimed is:

1. A computer-implemented method, comprising:
performing, by a first party of two parties, masking on three first-party fragments corresponding to three types of training data for a logistic regression model joint training by, respectively, using first fragments of three random numbers in a first fragment of a random array to obtain three first mask fragments, wherein the logistic regression model joint training comprises the three types of training data: a sample characteristic, a sample label, and a model parameter, and wherein each of the three types of training data is split into fragments that are distributed between the two parties;
sending, by the first party of two parties, the three first mask fragments to a second party, wherein the first fragment of the random array is a fragment, sent by a third party to the first party, of two-party fragments that are obtained by splitting values in the random array generated by the third party;
constructing, by the first party of two parties, three pieces of mask data corresponding to the three types of training data by using the three first mask fragments and three second mask fragments received from the second party; and
performing, by the first party of two parties, a first calculation based on the three pieces of mask data and the first fragment of the random array to obtain a first gradient fragment for updating the first-party fragment of the model parameter, wherein the first calculation is determined based on a Taylor expansion of a gradient calculation of a logistic regression model.

2. The computer-implemented method of claim 1, wherein:
the first party holds the sample characteristic and the second party holds the sample label; and
before obtaining the three first mask fragments:
splitting the sample characteristic into a corresponding first-party fragment and a corresponding second-party fragment by using a secret sharing technology, and sending the corresponding second-party fragment to the second party; and
receiving, from the second party, a first-party fragment obtained by splitting the sample label by using the secret sharing technology.

3. The computer-implemented method of claim 2, wherein, before obtaining the three first mask fragments:
after initializing, as an initialized model parameter, the model parameter:
splitting the model parameter into a corresponding first-party fragment and a corresponding second-party fragment; and
sending the corresponding second-party fragment to the second party; or
receiving, from the second party, a first-party fragment obtained by splitting the initialized model parameter by using the secret sharing technology.

4. The computer-implemented method of claim 1, wherein performing masking on three first-party fragments corresponding to the three types of training data by, respectively, using first fragments of three random numbers to obtain three first mask fragments, comprises:
for any type of training data, performing masking on a first-party fragment of the type of training data by using a first fragment of a random number having a same dimension as the type of training data to obtain a corresponding first mask fragment.

5. The computer-implemented method of claim 1, wherein constructing three pieces of mask data corresponding to the three types of training data by using the three first mask fragments and three second mask fragments received from the second party, comprises:
for any type of training data, constructing corresponding mask data by using a first mask fragment and a second mask fragment of the type of training data.

6. The computer-implemented method of claim 1, wherein:
the random array further comprises a fourth random number;
the three random numbers comprise a second random number corresponding to the model parameter;
the three pieces of mask data comprise characteristic mask data corresponding to the sample characteristic; and
after constructing the three pieces of mask data corresponding to the three types of training data and before obtaining the first gradient fragment:
determining a first product mask fragment corresponding to a product result of the second random number and the characteristic mask data based on a first fragment of the second random number, the characteristic mask data, and a first fragment of the fourth random number, and sending the first product mask fragment to the second party;
constructing product mask data corresponding to the product result by using the first product mask fragment and a second product mask fragment corresponding to the product result received from the second party; and
performing, by the first party of two parties, a first calculation based on the three pieces of mask data and the first fragment of the random array comprises:
further performing the first calculation based on the product mask data.

7. The computer-implemented method of claim 1, wherein:
the random array further comprises a plurality of additional values, and the plurality of additional values are values obtained by the third party by performing an operation based on the three random numbers; and
performing a first calculation based on the three pieces of mask data and the first fragment of the random array to obtain a first gradient fragment comprises:
calculating gradient mask data corresponding to a training gradient based on the three pieces of mask data;
calculating a first removal fragment for a mask in the gradient mask data based on the three pieces of mask data, the first fragments of three random numbers, and a first fragment of the plurality of additional values; and
performing de-masking on the gradient mask data by using the first removal fragment to obtain the first gradient fragment; or
determining the first removal fragment as the first gradient fragment.

8. The computer-implemented method of claim 1, wherein, after obtaining the first gradient fragment:
subtracting a product of a predetermined learning rate and the first gradient fragment from the first-party fragment of the model parameter as an updated first-party fragment of the model parameter.

9. A non-transitory, computer-readable medium storing one or more instructions executable by a computer system to perform operations, comprising:
performing, by a first party of two parties, masking on three first-party fragments corresponding to three types of training data for a logistic regression model joint training by, respectively, using first fragments of three random numbers in a first fragment of a random array to obtain three first mask fragments, wherein the logistic regression model joint training comprises the three types of training data: a sample characteristic, a sample label, and a model parameter, and wherein each of the three types of training data is split into fragments that are distributed between the two parties;
sending, by the first party of two parties, the three first mask fragments to a second party, wherein the first fragment of the random array is a fragment, sent by a third party to the first party, of two-party fragments that are obtained by splitting values in the random array generated by the third party;
constructing, by the first party of two parties, three pieces of mask data corresponding to the three types of training data by using the three first mask fragments and three second mask fragments received from the second party; and
performing, by the first party of two parties, a first calculation based on the three pieces of mask data and the first fragment of the random array to obtain a first gradient fragment for updating the first-party fragment of the model parameter, wherein the first calculation is determined based on a Taylor expansion of a gradient calculation of a logistic regression model.

10. The non-transitory, computer-readable medium of claim 9, wherein:
the first party holds the sample characteristic and the second party holds the sample label; and
before obtaining the three first mask fragments:
splitting the sample characteristic into a corresponding first-party fragment and a corresponding second-party fragment by using a secret sharing technology, and sending the corresponding second-party fragment to the second party; and
receiving, from the second party, a first-party fragment obtained by splitting the sample label by using the secret sharing technology.

11. The non-transitory, computer-readable medium of claim 10, wherein, before obtaining the three first mask fragments:
after initializing, as an initialized model parameter, the model parameter:
splitting the model parameter into a corresponding first-party fragment and a corresponding second-party fragment; and
sending the corresponding second-party fragment to the second party; or
receiving, from the second party, a first-party fragment obtained by splitting the initialized model parameter by using the secret sharing technology.

12. The non-transitory, computer-readable medium of claim 9, wherein performing masking on three first-party fragments corresponding to the three types of training data by, respectively, using first fragments of three random numbers to obtain three first mask fragments, comprises:
for any type of training data, performing masking on a first-party fragment of the type of training data by using a first fragment of a random number having a same dimension as the type of training data to obtain a corresponding first mask fragment.

13. The non-transitory, computer-readable medium of claim 9, wherein constructing three pieces of mask data corresponding to the three types of training data by using the three first mask fragments and three second mask fragments received from the second party, comprises:
for any type of training data, constructing corresponding mask data by using a first mask fragment and a second mask fragment of the type of training data.

14. The non-transitory, computer-readable medium of claim 9, wherein:
the random array further comprises a fourth random number;
the three random numbers comprise a second random number corresponding to the model parameter;
the three pieces of mask data comprise characteristic mask data corresponding to the sample characteristic; and
after constructing the three pieces of mask data corresponding to the three types of training data and before obtaining the first gradient fragment:
determining a first product mask fragment corresponding to a product result of the second random number and the characteristic mask data based on a first fragment of the second random number, the characteristic mask data, and a first fragment of the fourth random number, and sending the first product mask fragment to the second party;
constructing product mask data corresponding to the product result by using the first product mask fragment and a second product mask fragment corresponding to the product result received from the second party; and
performing, by the first party of two parties, a first calculation based on the three pieces of mask data and the first fragment of the random array comprises:
further performing the first calculation based on the product mask data.

15. The non-transitory, computer-readable medium of claim 9, wherein:
the random array further comprises a plurality of additional values, and the plurality of additional values are values obtained by the third party by performing an operation based on the three random numbers; and
performing a first calculation based on the three pieces of mask data and the first fragment of the random array to obtain a first gradient fragment comprises:
calculating gradient mask data corresponding to a training gradient based on the three pieces of mask data;
calculating a first removal fragment for a mask in the gradient mask data based on the three pieces of mask data, the first fragments of three random numbers, and a first fragment of the plurality of additional values; and
performing de-masking on the gradient mask data by using the first removal fragment to obtain the first gradient fragment; or
determining the first removal fragment as the first gradient fragment.

16. The non-transitory, computer-readable medium of claim 9, wherein, after obtaining the first gradient fragment:
subtracting a product of a predetermined learning rate and the first gradient fragment from the first-party fragment of the model parameter as an updated first-party fragment of the model parameter.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
performing, by a first party of two parties, masking on three first-party fragments corresponding to three types of training data for a logistic regression model joint training by, respectively, using first fragments of three random numbers in a first fragment of a random array to obtain three first mask fragments, wherein the logistic regression model joint training comprises the three types of training data: a sample characteristic, a sample label, and a model parameter, and wherein each of the three types of training data is split into fragments that are distributed between the two parties;
sending, by the first party of two parties, the three first mask fragments to a second party, wherein the first fragment of the random array is a fragment, sent by a third party to the first party, of two-party fragments that are obtained by splitting values in the random array generated by the third party;
constructing, by the first party of two parties, three pieces of mask data corresponding to the three types of training data by using the three first mask fragments and three second mask fragments received from the second party; and
performing, by the first party of two parties, a first calculation based on the three pieces of mask data and the first fragment of the random array to obtain a first gradient fragment for updating the first-party fragment of the model parameter, wherein the first calculation is determined based on a Taylor expansion of a gradient calculation of a logistic regression model.

18. The computer-implemented system of claim 17, wherein:
the first party holds the sample characteristic and the second party holds the sample label; and
before obtaining the three first mask fragments:
splitting the sample characteristic into a corresponding first-party fragment and a corresponding second-party fragment by using a secret sharing technology, and sending the corresponding second-party fragment to the second party; and
receiving, from the second party, a first-party fragment obtained by splitting the sample label by using the secret sharing technology.

19. The computer-implemented system of claim 18, wherein, before obtaining the three first mask fragments:
after initializing, as an initialized model parameter, the model parameter:
splitting the model parameter into a corresponding first-party fragment and a corresponding second-party fragment; and
sending the corresponding second-party fragment to the second party; or
receiving, from the second party, a first-party fragment obtained by splitting the initialized model parameter by using the secret sharing technology.

20. The computer-implemented system of claim 17, wherein performing masking on three first-party fragments corresponding to the three types of training data by, respectively, using first fragments of three random numbers to obtain three first mask fragments, comprises:
for any type of training data, performing masking on a first-party fragment of the type of training data by using a first fragment of a random number having a same dimension as the type of training data to obtain a corresponding first mask fragment.
